(19) United States
(12) Patent Application Publication
(10) Pub. No.: US 2005/0237147 A1
(43) Pub. Date: Oct. 27, 2005

(54) FUSE HOLDER SYSTEM

(75) Inventor: Joan Carreras, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/709,259

(22) Filed: Apr. 24, 2004

(51) Int. Cl. H01H 85/20; H01H 85/02

(52) U.S. Cl. 337/186

(57) ABSTRACT

It is materialised in a fuse holder module (1) in which housings (2) and (4) of suitable number and shape are arranged for the different fuses (3) and (5) involved in a diagnostic or periodic control operation of vehicle safety systems, such as ABS, airbags, brake control or others, such that the disconnection of said fuse holder module (1) from the main electric junction box of the vehicle entails the simultaneous global disconnection of all the fuses associated to said module. A cover (7) joined with a single piece character to the fuse holder module (1) through a joint (8) closes the housings (2) and (4) for the fuses (3) and (5), and maintains these perfectly stabilized inside the fuse holder module (1).

### BACKGROUND OF INVENTION

1. Field of the Invention

The present invention refers to a fuse holder system, consisting of a module capable of housing various fuses physically independent from one another, which for safety reasons must be associated but can be connected and disconnected at will.

2. Object of the Invention

The object of the invention is to achieve a system which, parallel to the possibility of unitary connection and disconnection of each one of said fuses, allows the connection and disconnection of the module as a whole from a main electric junction box, with a view to facilitating determined periodic safety controls on the circuits to which the fuses are associated.

The fuse holder system proposed by the invention proves especially suitable for use in the scope of automotive vehide safety systems, such as ABS, airbags, brake control and others.

In the scope of practical application of the invention which has just been mentioned, periodic safety controls are frequent, wherein the programming and testing of those safety systems having electronic elements are carried out through the electric wiring.

These safety controls entail the need of unitary removal of each one of the fuses involved in the safety systems, which as well as implying a significant degree of handling, with the consequent loss of time, it implies a permanent risk of error on the part of the handler, who after completing the safety control can reinsert the fuses in the incorrect housings, such that said fuses do not meet the function for which they have been provided, allowing a greater or lesser load than the nominal load of the corresponding circuit.

### DESCRIPTION OF THE INVENTION

The fuse holder system proposed by the invention solves the aforementioned problem in an entirely satisfactory manner, such that, in a single module, it is capable of housing an undetermined number of fuses, specifically all those involved in a periodic safety control operation, such that while said fuses remain unitarily operatable, as is compulsory and conventional, they can be removed as a block, in the aforementioned diagnostic operations, by means of removing the fuse holder module from the corresponding main electric junction box of the vehicle.

More specifically, the fuse holder module includes a group with housings for those fuses for which it has been provided, with the special particularity that a cover capable of closing the mouth of the different housings, and consequently of conveniently fixing the fuses to the module, is integrated on said body with a single piece character and by means of a pivoting hinge.

Parallel, the fuse holder module mentioned will further incorporate a fixing element for fixing it to the rest of the main electric junction box of the vehicle.

### BRIEF DESCRIPTION OF DRAWINGS

In order to complement the description being carried out and for the purpose of helping to better understand the features of the invention, according to a preferred practical embodiment thereof, a set of drawings is attached as an integral part of said description, wherein the following are represented with an illustrative and non-limiting character:

FIG. 1 shows an exploded perspective view of a fuse holder system carried out according to the object of the present invention, specifically according to a practical embodiment variant in which the fuse holder module is intended to house three fuses.

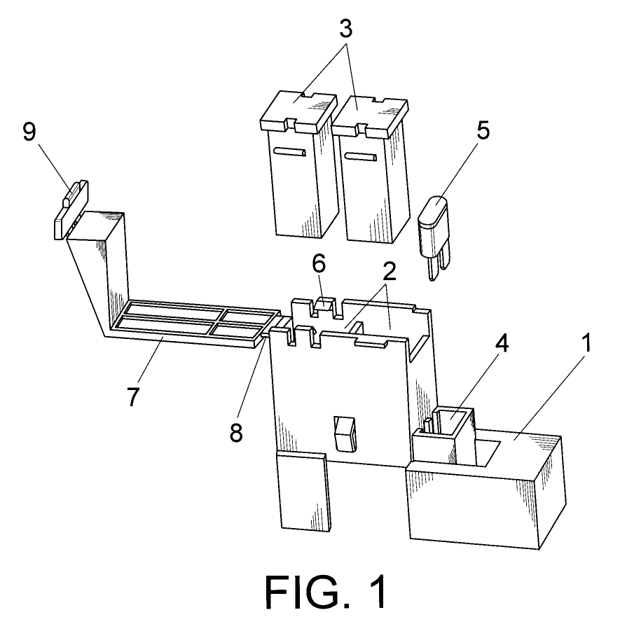

FIG. 2 shows, according to a similar representation to FIG. 1, the joint risk of said figure after the insertion of the fuses in the corresponding housings.

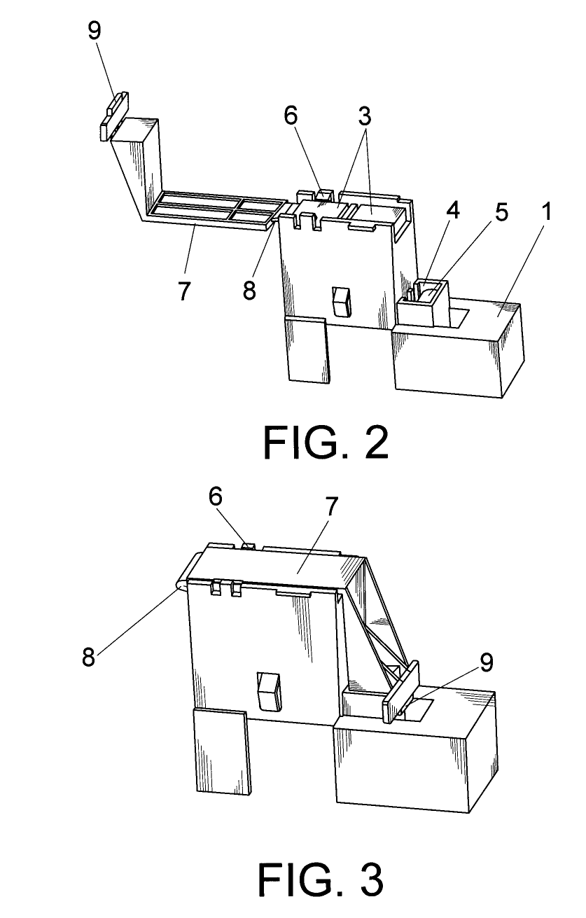

Finally, FIG. 3 shows the assembly of the previous figure duly closed.

### DETAILED DESCRIPTION

In view of the figures described, it can be observed how fuse holder system proposed by the invention is materialized in a fuse holder module (1), which in the practical embodiment chosen in the figures has a pair of housings (2) for the same number of cartridge type fuses (3), as well as a third housing (4) for a conventional fuse (5), which fuses can remain stabilized inside their respective housings by simple pressure or by any other means.

In any case, the definitive fixing of the fuses (3) and (5) is determined by a cover (7), a single piece with the module (1) and joined thereto by means of a pivoting line (8) acting as a joint or a swinging hinge, which cover (7), with a stepped configuration, covers the mouth of both the housings (2) and the housing (4), as can be seen especially in FIG. 3, using resiliently deformable lugs (6) for the stabilization thereof in a closed position, said lugs acting as resilient hooks, as well as a fixing lug (9) arranged on the free end of said arm (7).

In this way and as previously stated, the fuse holder module (1) as a whole, i.e. with the different fuses (3) and (5) associated thereto, can be made independent in an extremely quick and simple manner from the main electric junction box of the vehicle, not shown in the drawing, when it is necessary to carry out any periodic safety control, the module (1) being subsequently reintegrated to said box as a whole and without the need for the classic unitary handling of each one of the fuses (3) and (5).

1. A fuse holder system which, being specially conceived to integrate the fuses involved in periodic controls or diagnoses of vehicle safety systems, such as abs, airbags, brake control or others, is characterized in that it consists of a fuse holder module (1) provided with a body capable of housing the different fuses (3-5) involved, which for safety reasons must be associated but with the possibility of being connected and disconnected at will, said body having two housings (2) and (4) for the fuses (3) and (5), with a cover (7) for closure of said housings, and with a fixing element fixing it to the main electric junction box of the vehicle.

2. A fuse holder system according to claim 1, characterized in that the housings (2) and (4) are variable in number and configuration, according to the number of fuses (3) and (5) involved and to the equal or different features thereof.

3. A fuse holder system according to previous claim 1, characterized in that the cover (7) for the housings (2) and (4) of the fuse holder module forms a single piece therewith, and is joined therewith through a pivoting line determining a joint or a swinging hinge (8), said cover (7) being provided with fixing means for fixing it to the module (1) in a closed position.

4. A fuse holder system according to previous claim 2, characterized in that the cover (7) for the housings (2) and (4) of the fuse holder module forms a single piece therewith, and is joined therewith through a pivoting line determining a joint or a swinging hinge (8), said cover (7) being provided with fixing means for fixing it to the module (1) in a closed position.
